(19) United States
(12) Patent Application Publication
(10) Pub. No.: US 2010/0326960 A1
(43) Pub. Date: Dec. 30, 2010

(54) Vacuum Interrupter Switch For Power Distribution Systems

(75) Inventors: Carl Heller, Brea, CA (US); Kaung-Chien Hu, Xinzhuang City (TW)

Correspondence Address: SELDON & SCILLIERI, 10940 WILSHIRE BLVD., 18TH FLOOR, LOS ANGELES, CA, 90024-3952, US

(73) Assignee: IMPACT POWER, INC., Irvine, CA (US)

(21) Appl. No.: 12/865,114

(22) PCT Filed: Feb. 25, 2009
(86) PCT No.: PCT/US09/35191

§ 371 Date: Jul. 28, 2010

Related U.S. Application Data
(60) Provisional application No. 61/031,154, filed on Feb. 25, 2008.

(51) Int. Cl. H01H 33/66

(52) U.S. Cl. 218/139

(57) ABSTRACT

A current interrupting switch for power distribution systems comprising an outer case and a plurality of vacuum interrupter bottle switches positioned in the case.

### CROSS REFERENCE TO RELATED APPLICATION

This application claims priority of co-pending U.S. Provisional Patent Application No. 61/031,154, filed Feb. 25, 2008 which is incorporated by reference in its entirety herein and a copy of which is attached hereto as Exhibit A and made a part of this application. To the extent that there may be a conflict between the contents of the text and figures of Exhibit A and the text and figures which are not part of Exhibit A, the contents of the text and figures which are not part of Exhibit A shall govern.

### FIELD OF THE INVENTION

The present invention pertains to current interrupting switches for power distribution systems. More particularly, the present invention relates to current interrupting switches for underground locations of power distribution systems.

### BACKGROUND

Electric utility power distribution systems are frequently constructed underground for a variety of reasons ranging from objections to the above-ground aesthetics, the premium of above-ground space in dense urban locations, and safety concerns. Accordingly, power distribution systems heretofore constructed of poles, wires, and pole-mounted switches and transformers are being superseded and even replaced by underground systems in underground “vaults”.

Space in underground installations is at a premium, and material must be able to fit through municipal access holes, imposing strict dimensional restrictions on any such material. At the same time, environmental and safety concerns have discouraged the use of such dielectric materials as oil and SF₆ which can be flammable and/or explosive while presenting environmental problems when leakage occurs or when emissions are created.

“Delta load” centers are located within underground vaults that are as much as a mile or more away from a utility substation. Customers receive power through these delta load centers. Each delta load center is comprised of three single-phase oil switch assemblies which each have four loadbreak switches connected to one another by a common bus. One loadbreak switch is connected to a feeder circuit and the other three are connected to radial branch underground circuits through paper-insulated lead cables (PILCs).

In order to provide power to the designated area, a three-phase feeder cable from the utility substation is brought to the delta load center, divided into three single cables which are each connected to the feeder loadbreak switch of an oil switch assembly. Three radial branch circuits are each connected to a loadbreak switch. Power is served to the customers when they are connected to the radial branch circuits.

The oil switch assemblies currently used in the delta load centers have typically comprised an electrically conductive bayonet-type switch element that is manually pushed in or pulled out between two electrically conductive terminals, one of which is connected to a common bus and the other is connected to the underground circuit. When inserted between the terminals, the bayonet electrically couples the terminals, completing the circuit and energizing the underground circuit. When manually pulled from the terminals, the switch breaks load current, “opens” the circuit, and de-energizes the underground circuit. The terminals and switch element are enclosed in a container that is oil filled.

The present invention pertains to current interrupter switches designed to replace oil switch assemblies used in underground “delta load” centers.

### SUMMARY OF THE INVENTION

The invention herein is a single phase, 4-way vacuum interrupter switch that meets the dimensional constraints imposed by utility demands while providing the safety and ecological benefits of a vacuum interrupting switch. The switch is located within the underground delta load center and, when installed, allows for the replacement of existing paper-insulated lead cables (PILC) with higher-rated synthetic cables. The switch herein is configured to fit through existing vault access holes which are typically 30 inches in diameter. Moreover, the present invention is useful in higher voltage delta single-phase vacuum switch feeders with three branch circuits as a drop-in replacement for the lower voltage oil switches currently installed in the underground delta load centers, and minimizes potential hazards such as oil leakage, explosion, and lead exposure within the confined space of underground delta load center.

Other objects, advantages and significant features of the invention will become apparent from the following detailed description, which, taken in conjunction with the annexed drawings, discloses a preferred embodiment of the invention.

It will be understood that orientations described in this specification, such as “up”, “down”, “top”, “side” and the like, are relative and are used for the purpose of describing the invention with respect to the drawings. Those of ordinary skill in the art will recognize that the orientation of the disclosed device can be varied in practice, and that the orientation used herein has been chosen for explanatory purposes only. Similarly, it will be recognized by those skilled in the art that the materials referred to herein, and particularly those identified by trademark, are examples of materials that meet the requirements and specifications mandated by safety concerns and by the use of the invention with electric power lines. Accordingly, other acceptable materials are within the scope of the invention whether known by generic names and/or other trademarks, or comprising other functionally equivalent material.

### DESCRIPTION OF THE DRAWING

In the drawing,

FIG. 1 is a top right angled view of a vacuum interrupter switch assembly constructed in accordance with the invention;

FIG. 2 is a top left angled view of the vacuum interrupter switch assembly of FIG. 1;

FIG. 3 is a top left rear angled view of the vacuum interrupter switch assembly of FIG. 1;

FIG. 4 is a bottom left angled view of the vacuum interrupter switch assembly of FIG. 1;

FIG. 5 is a top view of the vacuum interrupter switch assembly of FIG. 1 without the lid, and illustrating the internal layout of components;

FIG. 6 is a bottom view of the vacuum interrupter switch assembly of FIG. 1 without the lid and bottom, illustrating the internal layout of components;

FIG. 7 is a front section expanded view of a vacuum interrupter bottle switch as illustrated in FIGS. 5 and 6;

FIG. 8 is a back section expanded view of a vacuum interrupter bottle switch with common bus assembly as illustrated in FIGS. 5 and 6 without the operating mechanism assembly;

FIG. 9 illustrating a Multilam® contact and C-clips which are inside the internal groove (not shown) of a common bus connector;

FIG. 10 is a wiring diagram illustrating the major electrical connections within the vacuum interrupter switch assembly;

FIG. 11 is intentionally left blank;

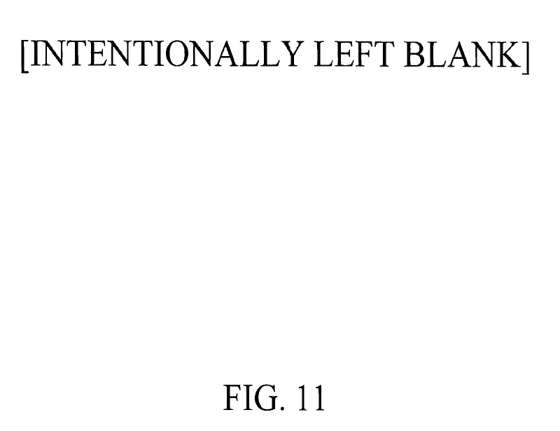

FIG. 12 is a top plan view of the operating mechanism assembly according to the present invention;

FIG. 13 is a side plan view of the operating mechanism assembly of FIG. 12;

FIG. 14 is an internal view of the operating mechanism assembly of FIG. 12;

FIG. 15 is an illustration of the draft shaft assembly of FIG. 12;

FIG. 16 is an illustration of the push-pull assembly of FIG. 12;

FIG. 17 is an illustration of the damper assembly of FIG. 12;

FIGS. 18A through 18K are illustrations of components of FIG. 12;

FIGS. 19A through 19J are illustrations of components of FIG. 12;

FIGS. 20A through 20N are illustrations of components of FIG. 12;

FIGS. 21A through 21H are illustrations of components of FIG. 12;

FIG. 22 is an expanded illustration of the top control assembly of FIG. 1;

FIG. 23 is an expanded illustration of the bottom control assembly of FIG. 4;

FIG. 24 is an assembled view of the vacuum interrupter bottle switch assembly as illustrated in FIGS. 5 and 6;

FIG. 25 is a cut-away top plan view of the vacuum interrupter switch assembly of FIG. 1, with its operating mechanism in cut-away view and some components not shown for clarity;

FIG. 26 is a cut-away right side view of the vacuum interrupter switch assembly of FIG. 1, with some components not shown for clarity;

FIG. 27 is a cut-away front view of the vacuum interrupter switch assembly of FIG. 1, with some components not shown for clarity;

FIG. 28 is a bottom plan view of the vacuum interrupter switch assembly of FIG. 6 illustrating the hydrocarbon foam as shaded for clarity.

### DETAILED DESCRIPTION OF THE PREFERRED EMBODIMENT

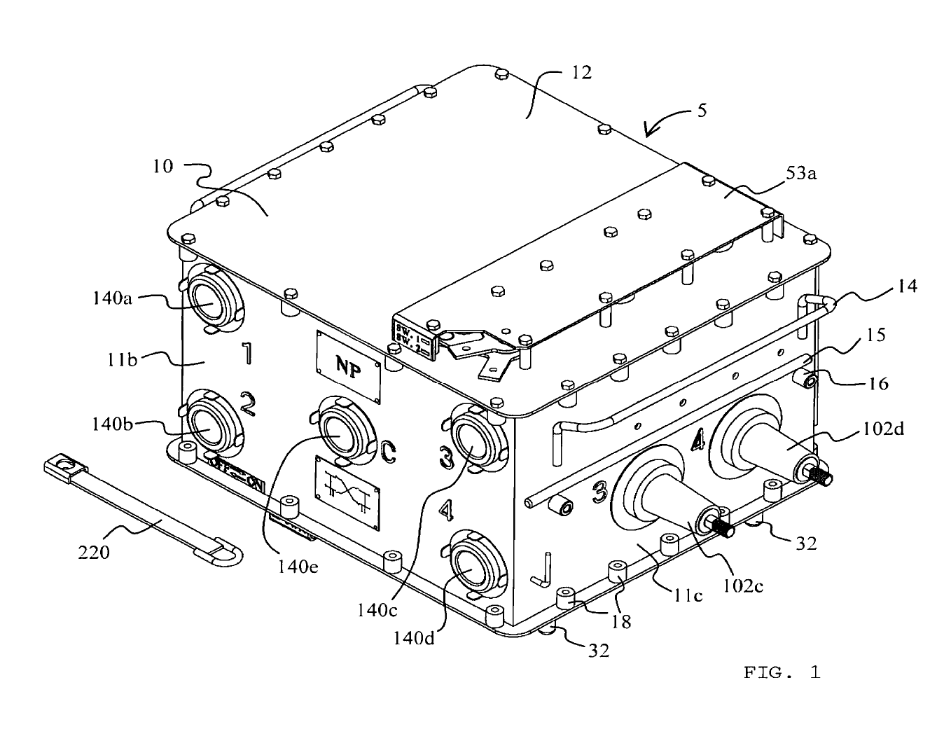

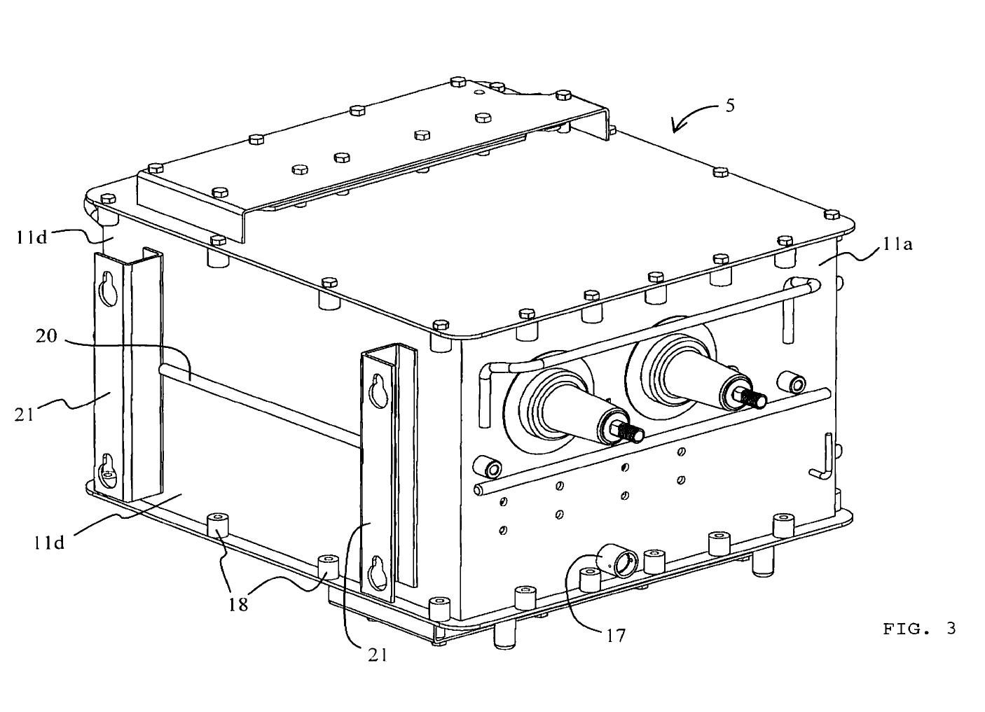

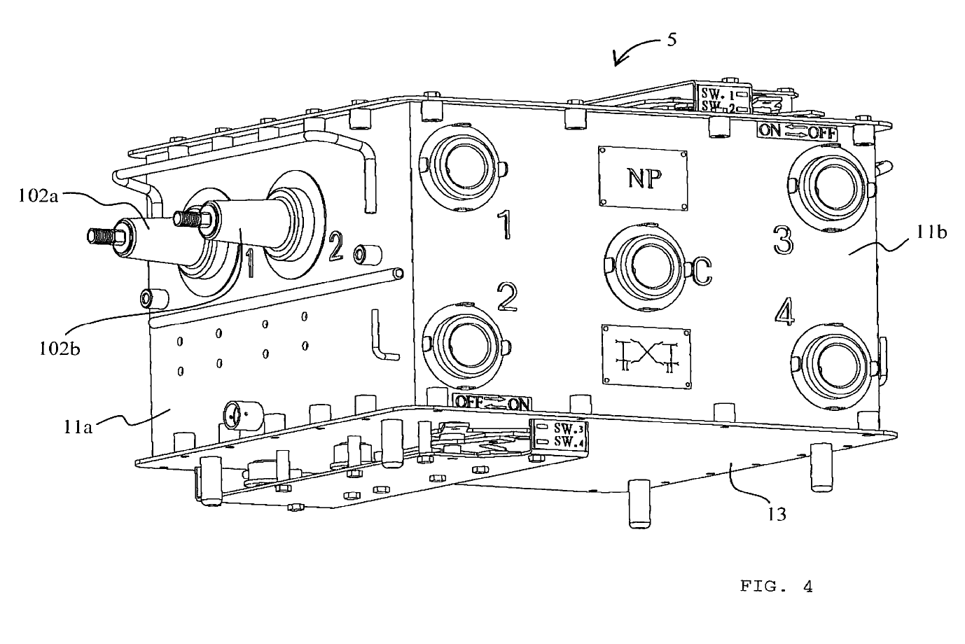

Referring to FIGS. 1-4, a vacuum interrupter switch assembly 5 constructed in accordance with the invention is illustrated. The assembly comprises of an outer case 10 with sidings 11a-d, bottom 12, and lid 13, formed from a sturdy, corrosive-resistant material. The preferred material is stainless steel. The dimensions of the case are preferably approximately 28.8 inches wide by 16.9 inches high by 21.5 inches deep to fit within existing access holes and underground spaces available for switching assemblies. Each switch assembly case 10 is filled with dry air. Neither oil nor SF₆ gas is used. The enclosed space may be filled with an electrically non-conductive moisture-resistant gel, if desired, once the assembly's internal components have been installed. The case 10 preferably has a welded lid 13.

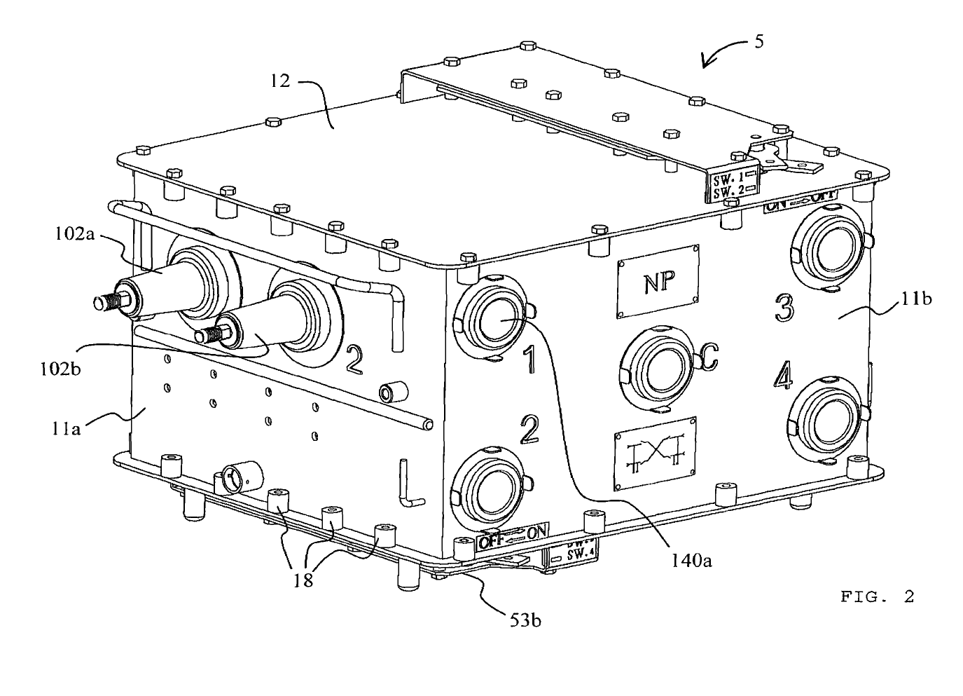

A first pair of 600 amp power bushings 102a, 102b extends from siding 11a of case 10. A second pair of 600 amp power bushings 102c, 102d extends from siding 11c of case 10. Five 200 amp bushing wells 140a, 140b, 140c, 140d, and 140e extend from siding 11b (front) of case 10. As illustrated in FIGS. 1 and 2, power bushings 102a and 102b extend from the upper region of the case, while power bushings 102c and 102d extend from the lower region of the case. In use, the incoming three-phase power feeder cable is electrically coupled to a selected one of the four power bushings. The remaining three power bushings are electrically coupled to the radial branch circuits to provide single-phase power. Because all the power bushings are rated at 600 amps, any of them may be selected as the bushing that receives the three-phase power feeder cable.

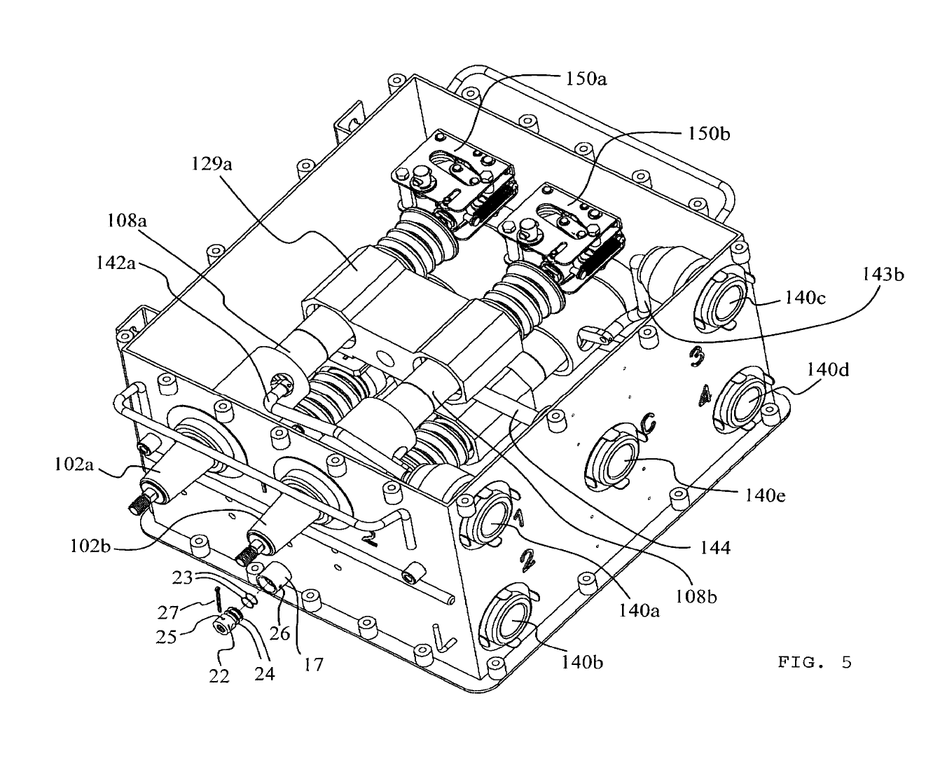

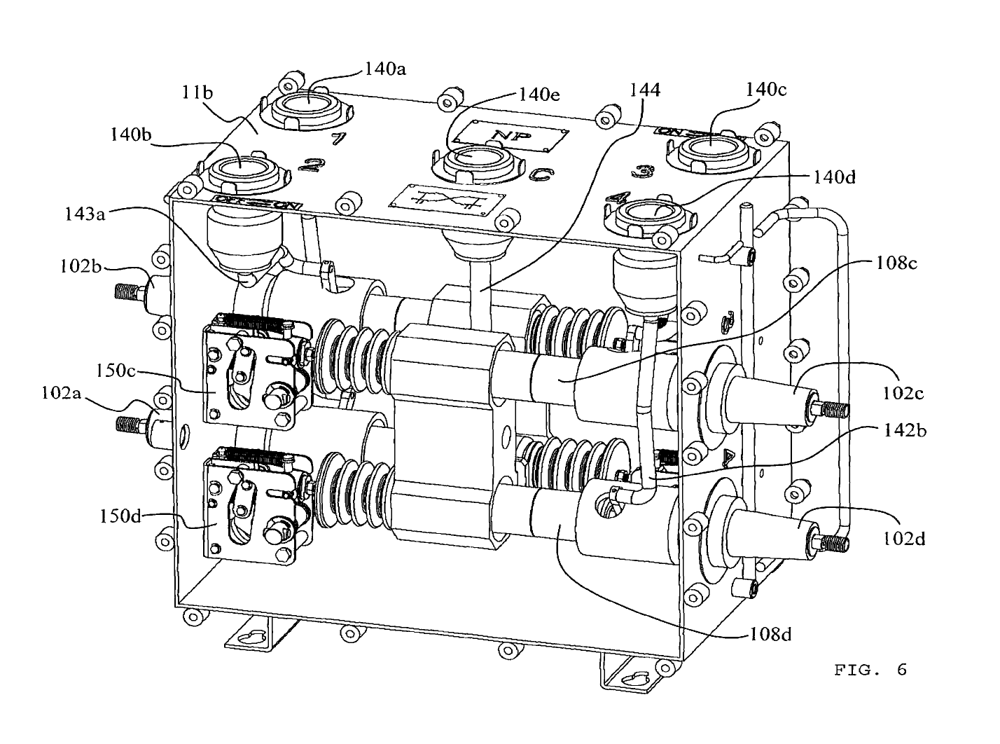

Referring next to FIGS. 5 and 6, the layout of the assembly's internal components is illustrated. The assembly includes four “vacuum interrupter bottle” switches 108a, 108b, 108c, and 108d electrically coupled to a respective one of the four power bushings 102a, 102b, 102c, or 102d. As illustrated in FIG. 5, vacuum interrupter bottle switch 108a is electrically coupled to power bushing 102a and extends laterally inward across the upper region of the case 10. Vacuum interrupter bottle switch 108b is electrically coupled to power bushing 102b and extends laterally inward across the upper region of the case 10, forward of vacuum interrupter bottle switch 108a and generally parallel thereto. As shown in FIG. 6, vacuum interrupter bottle switch 108c is electrically coupled to power bushing 102c and extends laterally inward across the lower region of the case 10 beneath vacuum interrupter bottle switch 108b and generally parallel thereto. The fourth vacuum bottle switch 108d is electrically coupled to power bushing 102d and extends laterally inward across the lower region of the case 10 beneath vacuum bottle switch 108a and generally parallel thereto.

Information regarding the general features and functions of vacuum bottle can be found in U.S. Pat. Nos. 3,305,657 and 5,589,675.

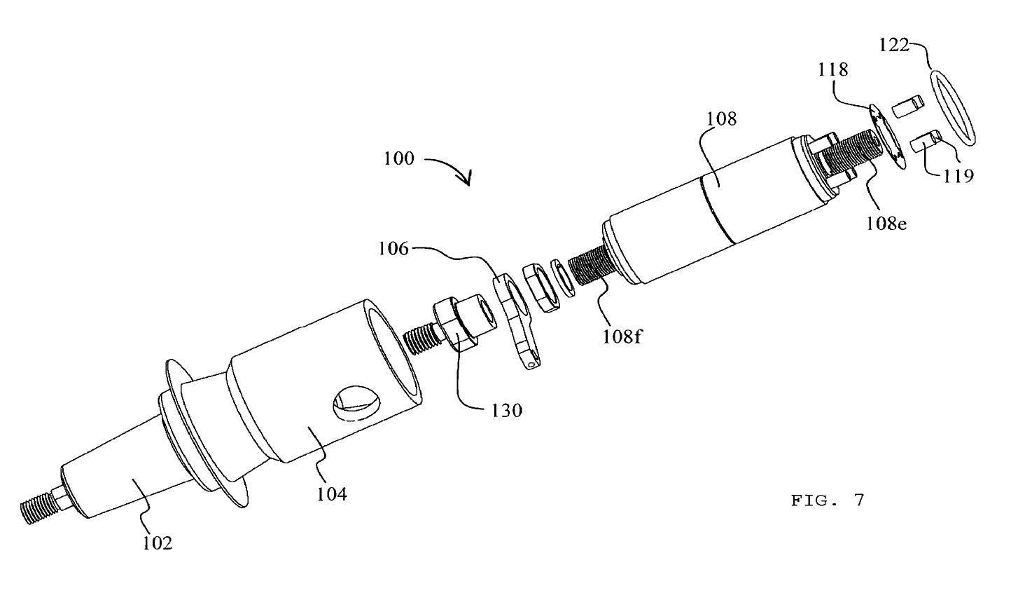

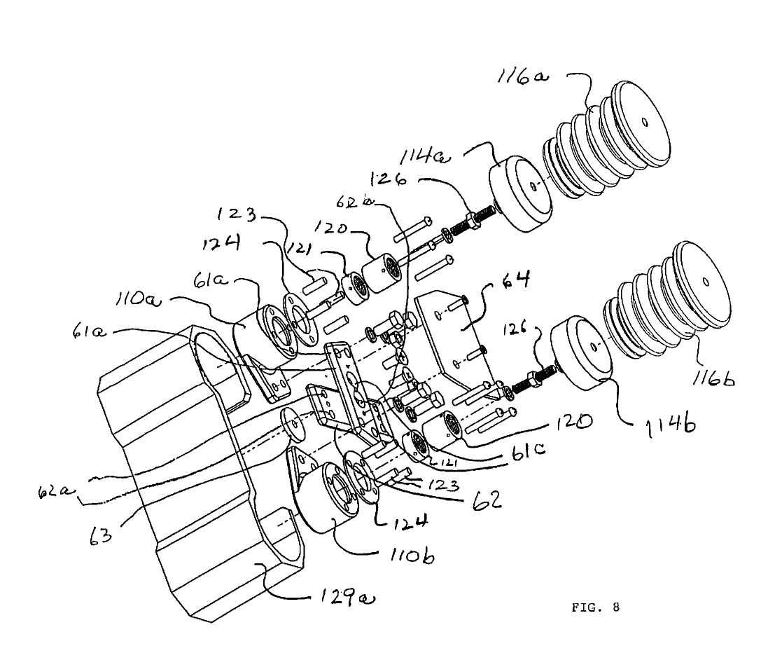

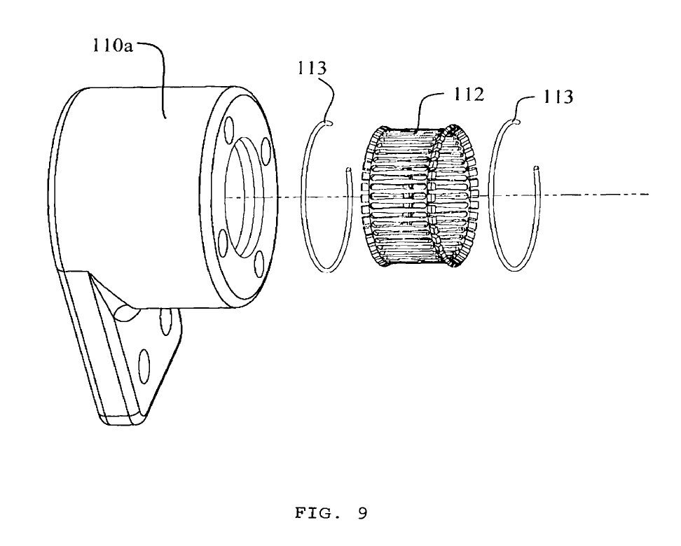

Referring to FIGS. 7 and 8, the layout of the vacuum interrupter bottle switches is illustrated. A vacuum interrupter bottle 108 has one stationary contact 108f and one moveable contact 108e. As illustrated in FIG. 7, each power bushing 102 is preferably connected to the stationary contact 108f of the respective vacuum interrupter bottle 108 and to a respective bushing well 140a, 140b, 140c, 140d through bushing well connector 106. The moveable contact of each vacuum interrupter bottle is connected to a respective push-pull insulator (e.g., at 116a) and (as best illustrated in FIG. 8) is in contact with a connector (e.g., 61a) to a common bus assembly for all four moving contacts. A respective common bus connector 110a, 100b is bolted directly to the moveable contact end of each vacuum interrupter bottle. The interior wall of common bus connector 110a, 110b has an internally disposed band of torsion or leaf spring contact material 112, as illustrated in FIG. 9, captured therein for electrical contact between the movable contact and the common bus assembly. Contact elements of this type are sold, for example, under the Multilam trademark. The Multilam contact touches the moveable contact of a vacuum interrupter bottle switch.

Each push-pull insulator 116a, 116b, 116c, 116d is connected to a respective operating mechanism assembly 150a, 150b, 150c, 150d that is controlled by means such as a removable handle or respective control signals. In the case of removable handles, the handle is operable through a respective control arm assembly located on the exterior of the case 10; preferably on the top or bottom side of the container. Each control arm assembly can be locked in place to prevent improper operation. Each vacuum interrupter bottle switch is preferably opened and closed through the force of a compression spring located in the operating mechanism to move the contacts at a specified speed. At the base of the connector is a flat bus which connects to a common bus assembly related to all four vacuum interrupter bottle switches. A threaded insert connects the moveable contact to a push-pull insulator.

The push-pull insulator is designed to isolate the grounded manually operated mechanism of the energized vacuum interrupter bottle switch when the movable contact is in the closed position. The push-pull insulator is made of an epoxy resin, and is shaped as a station-type insulator. A cup-shaped insulator provides additional insulation when the vacuum interrupter bottle switch is in the closed position. Both ends of the push-pull insulator have threaded bolts that are secured in place using a locking nut.

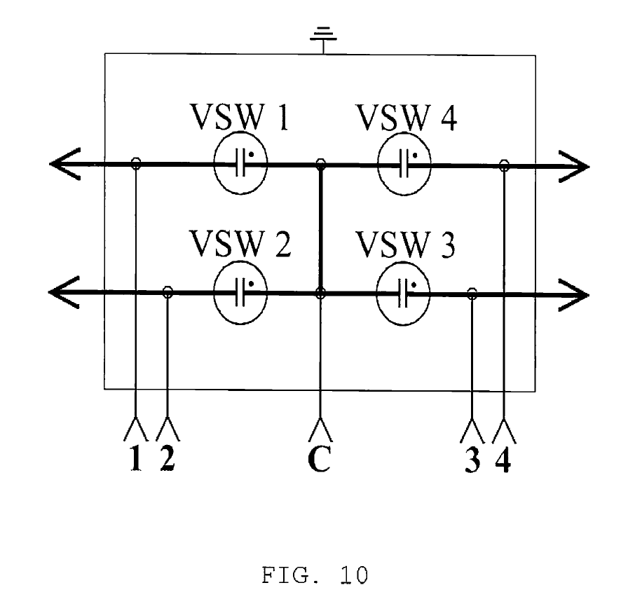

The connection of each bushing well 140a, 140b, 140c, 140d directly to a respective power bushing 102a, 102b, 102c, 102d, respectively (as illustrated in FIGS. 5, 6, and 10) allows checking of the potential and grounding of the power circuit as well as allowing emergency power input to the power circuit during an outage due to loss of power to the feeder circuit. The fifth bushing well 140e is connected to the common bus assembly 60 so as to provide a ground in checking for voltage and to provide a point for measuring the vacuum interrupter bottle switch contact resistance. The design functions of the four bushing wells 140a, 140b, 140c, 140d are to:

1. ground a de-energized branch circuit as required.

2. determine if the circuit is energized. A high voltage voltmeter can be used to determine the voltage magnitude between phases (A-B; B-C; C-A).

3. provide a temporary source of electric power to the branch circuit under an emergency condition in the event a feeder is de-energized.

4. measure with instruments, without removal from the case, the vacuum interrupter bottle switches' contact resistances and vacuum dielectrics when the vacuum interrupter switch assembly is de-energized.

Each power bushing 102a, 102b, 102c, 102d is preferably connected directly to the stationary contact of a respective vacuum interrupter bottle switch via a threaded connector. The bottom side of the connector contains a bus for connection to a 200 A jumper with a threaded connector from the bushing well. The gap between the 600 A bushing and the vacuum interrupter bottle switch insulation is increased using a mold of epoxy resin.

Each case 10 has ground rods 19 welded on the left and right side of the case. Choosing a side, the three installed vacuum interrupter switch assemblies are grounded and bonded together with a ground cable connected to the ground rod 19. The cable should be connected to a low impedance ground to provide: a) protection by limiting voltage stress to the energized components and b) maximum safety to persons who operate or come in contact with the container when it is energized.

With the availability of this new switch assembly, the existing PILC can be replaced with synthetic cable. The utilization of the bushings allows connection to the vacuum interrupter switch assemblies via synthetic power cable elbows such as those manufactured under the Elastimold trademark by Thomas & Betts Corporation (Memphis, Tenn., USA) and under the Cooper trademark by Cooper Power Systems (Waukesha, Wis., USA). For this invention, Elastimold is the preferred brand. With the oil switch assemblies, bushings are not used so synthetic power cable elbows cannot be connected. The oil switches have metal end caps to which holes are drilled so that PILC can be inserted into the oil switch. In order to secure the cable to the oil switch, lead swipes are used. The use of bushings foregoes this toxic process.

An underground delta load center usually has a 30-inch diameter access hole. This size hole is large enough for three of the disclosed assemblies to fit through, end first, one at a time. For installation, two stainless steel wall mounting brackets are installed onto the wall first. The first assembly is preferably installed at the lowest point on the wall mounting brackets and provides a shelf for lifting and landing the next assembly in place. Mounting brackets with slotted holes are preferably located on the back side of the case 10 for easy installation.

A summary of other features and other specifications attributable to the assembly herein are shown below.

### Capabilities

600 A Loadbreak 4-Way Vacuum Interrupter Switch
200 A Loadbreak 4-Way Vacuum Interrupter Switch
200 A 1-Way Vacuum Interrupter Switch
200 A Brushing Voltage Checking
200 A Phase Grounding
200 A Power Input

### Features

No oil and no SF6 gas. Interrupting is inside vacuum interrupter.
Standard brushing and brushing wells. IEEE/ANSI
Submersible, compact and light-weight design.
Manual operation.
All mechanisms and switch tank are made of stainless steel.
All lines and common bus are individually accessible through 200 A brushing wells.
Optional molecular sieves.

### Benefits

Environmentally friendly. Maintenance-free and safe operation and long service.
Ease of cable connection.
Best choice for underground applications. Can fit through 30″ dia. maintenance holes.
No special operation tools requirement.
Corrosion-free service.
Ease in grounding or detection.
Increased moisture protection.

If smaller dimensions are desired, oil or SF₆ can still be used in the disclosed assembly as a dielectric medium.

The assembly of the preferred vacuum interrupter switch assembly will now be discussed.

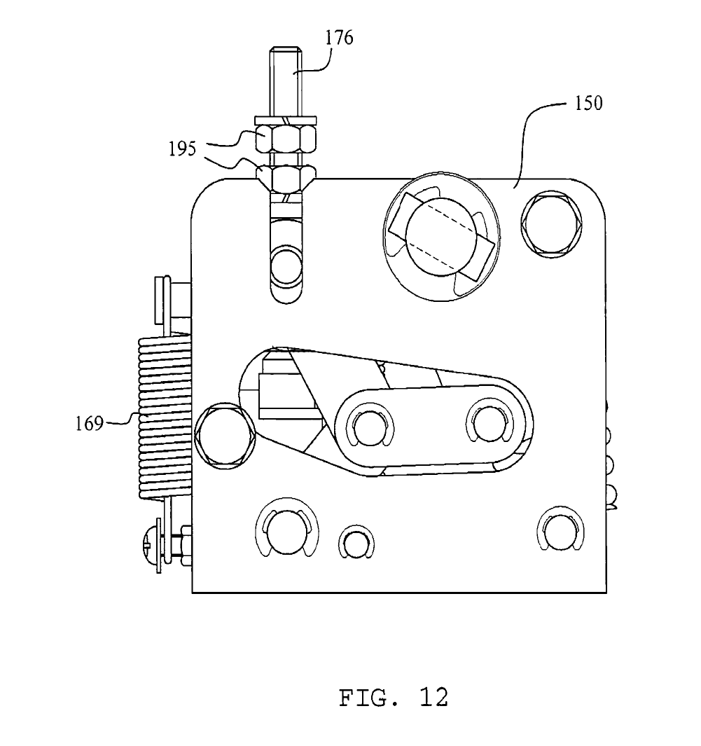

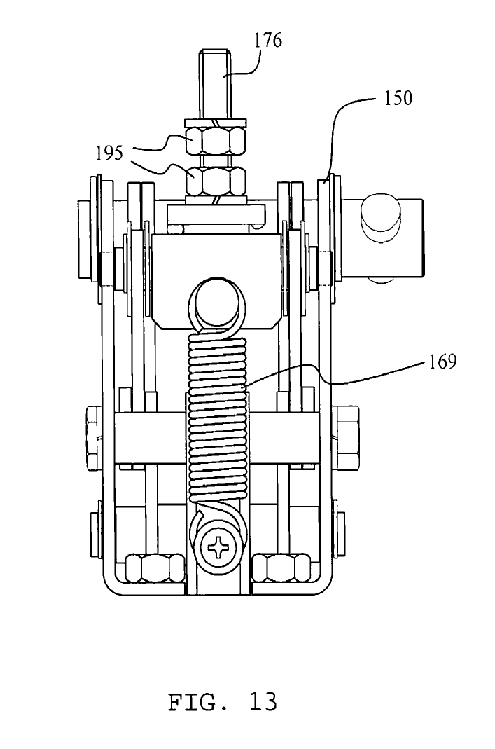

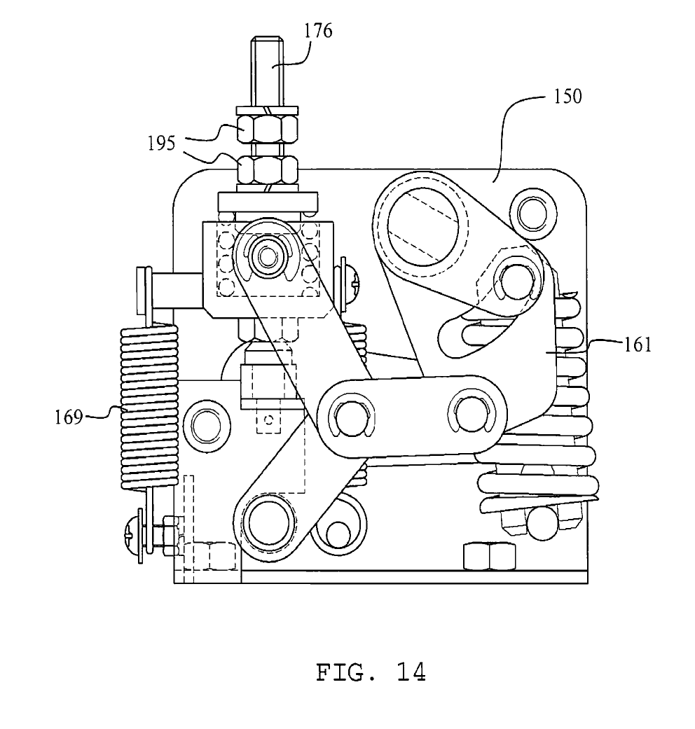

FIGS. 12-14 show views of an operating mechanism assembly 150 according to the present invention. The operating mechanism assembly 150 is generally comprised of a drive shaft assembly, push-pull assembly, damper assembly, and framing components. According to the present invention, four operating mechanisms are used and designated as 150a, 150b, 150c, and 150d (in FIGS. 5 and 6).

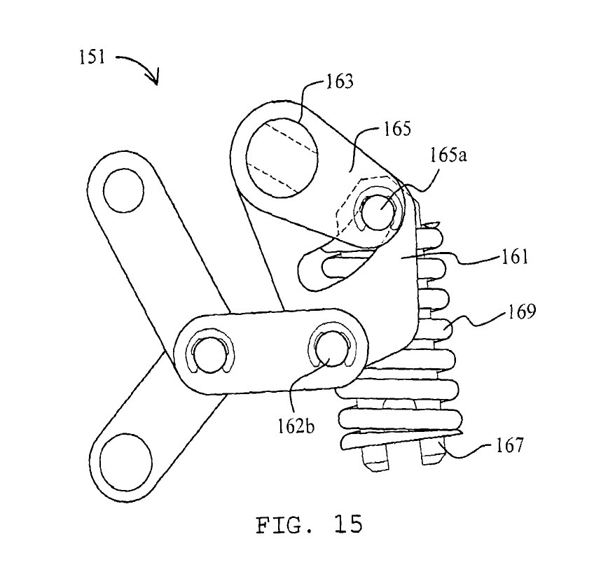

Referring to FIGS. 15, 18A through 18K and 19A through 19J, the drive shaft assembly is assembled with drive shaft 163 fitted through clevis shaft 164 of clevis 161 and rotating clevis 165. Spring shaft 167 is secured to clevis 161 and rotating clevis 165 by inserting pin 166 through holes 165a, curved slots 161a, and pivot point 167a. Spring 169 is slid onto spring shaft 167 and held in place with screws at points 167c. Pin 166 is fastened by retaining washers 205. End 170c of toggle link 170a is fastened to pivot point 162a with retaining washer 205. End 170d of toggle link 170a along with end 171c of toggle link 171a is fastened by retaining washers 205 to pivot point 173a of clevis 172. Toggle link 170b is substantially identical in structure to toggle link 170a. One end of toggle link 170b is fastened to pivot point 162b with retaining washer 205. End 170c of toggle link 170b along with the end 171c of toggle link 171b is fastened by retaining washers 205 to pivot point 173b of clevis 172. Toggle link 171b is substantially identical in structure to toggle link 171a.

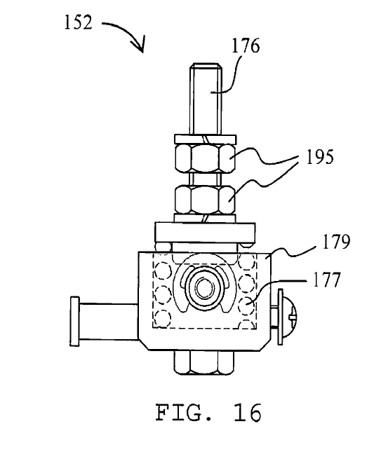

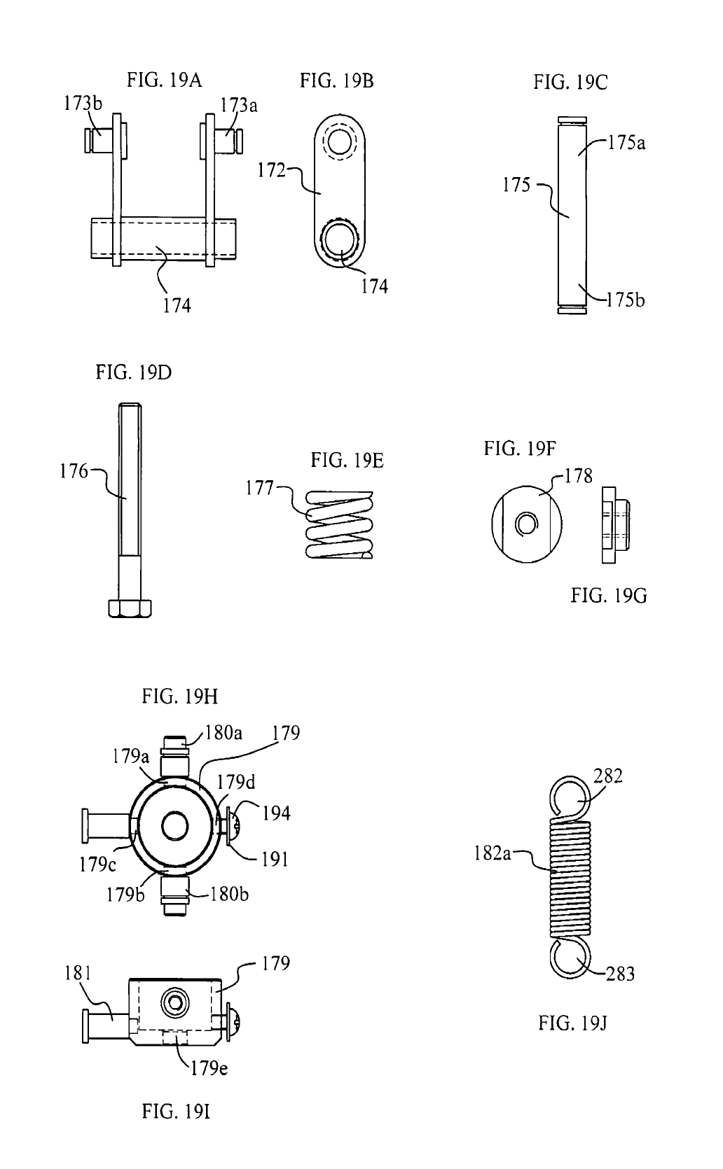

Referring to FIGS. 16 and 19, the push-pull assembly is assembled with bolt 176 inserted into hole 179e of spring container 179 and through over-travel spring 177. Spring holder 178 is screwed down onto bolt 176 to hold over-travel spring 177 in place. A spring washer 196, two nuts 195, and a second spring washer 196 are screwed onto bolt 176. Pivot studs 180a and 180b are welded into spring container 179 at holes 179a and 179b, respectively. After end 282 of spring 182a is attached to spring support 181, spring support 181 is welded into hole 179c of spring container 179. After end 283 of spring 182b is attached to support screw 194 with washer 191, support screw 194 is screwed into hole 179d. Spring 182b is substantially structurally identical to spring 182a.

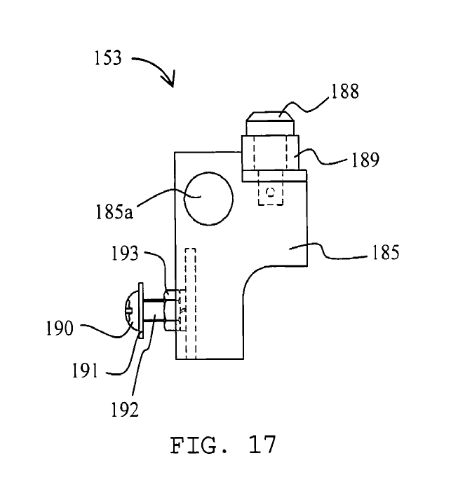

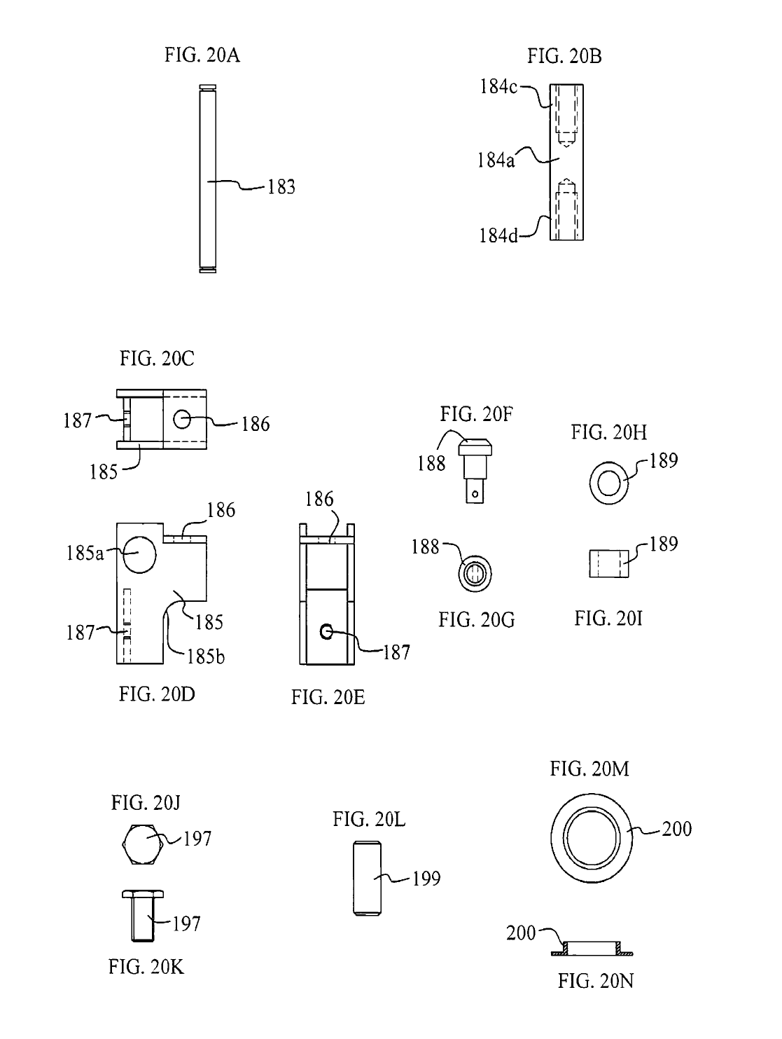

Referring to FIGS. 17 and 20, the damper assembly 153 includes a stopper 188 which is inserted through spacer 189, through hole 186 on support 185 and held in place with a cotter pin. Support screw 190 is fitted with flat washer 191, nut 193 and spring washer 192 and then screwed into hole 187 of support 185.

Drive shaft assembly 151 is connected to push-pull assembly 152 by fastening end 271 of toggle link 171a to pivot stud 180a of spring container 179 with retaining washer 204 and fastening end 271 of toggle link 171b to pivot stud 180b of spring container 179 with retaining washer 204.

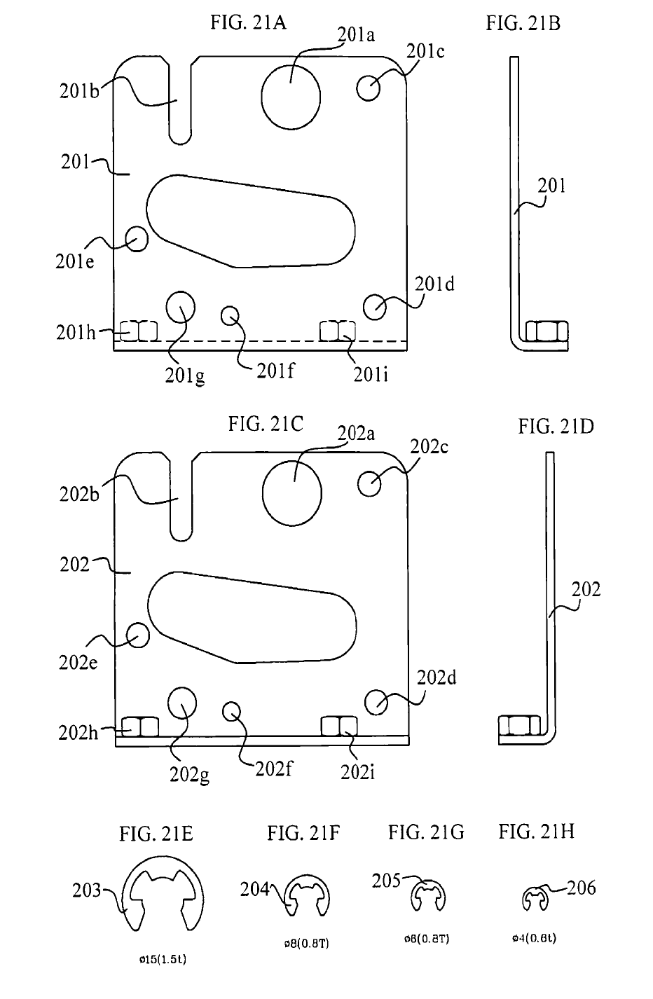

Referring to FIGS. 20A through 20N and 21A through 21H, flanged spacers 200 are inserted into hole 202a on frame 202 and hole 201a on frame 201 from the non-flanged side. End 163a of drive shaft 163 is inserted into flanged spacer 200 of frame 202 and fastened with retaining washer 203. Pivot stud 180a is inserted into slot 202b on frame 202. Bolt 197 is inserted into hole 202c of frame 202 and screwed into threaded spacer 184a at end 184c. A second bolt 197 is inserted into hole 202e of frame 202 and screwed into threaded spacer 184b at end 184c. Pivot rod 175 is inserted into pivot shaft 174 of clevis 172 with end 175a inserted into hole 202g and fastened in place with retaining washer 204. Damper assembly 153 is installed onto spacer 184b through hole 185a and positioned between the arms of clevis 172 supporting pivot shaft 174 at support point 185b.

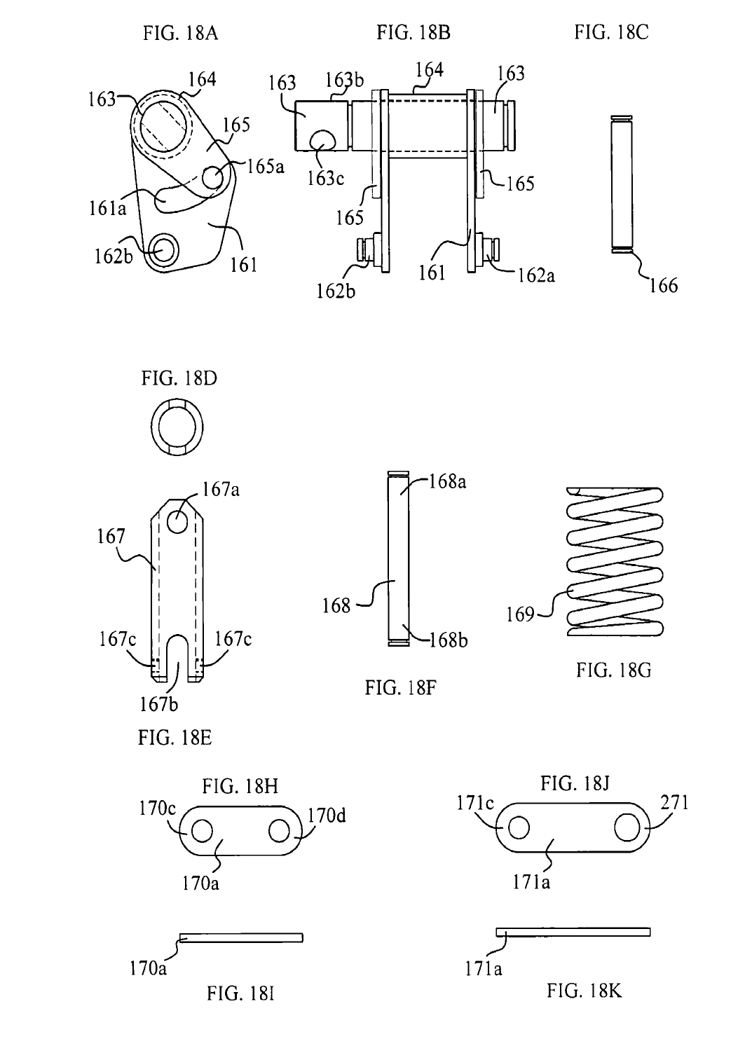

Additionally referring to FIGS. 18A through 18K and 19A through 19J, end 163b of drive shaft 163 is inserted through flanged spacer 200 of frame 201 and fastened with retaining washer 203. Pivot stud 180b is inserted into slot 201b on frame 201. Bolt 198 is inserted into hole 201c of frame 201 and screwed into threaded spacer 184a at end 184d. A second bolt 198 is inserted through hole 201e of frame 201 and screwed into threaded spacer 184b (which is substantially the same in structure as 184a) at end 184d. End 175b of pivot rod 175 is inserted through hole 201g and fastened into place with retaining washer 204. Rod 183 is inserted through hole 202f, spring end 283, and into hole 201f. Retaining washers 206 fasten rod 183 into place. Pin 168 is inserted through hole 202d, slot 167b, through hole 201d and fastened in place with retaining washers 205. Spring end 283 is hooked onto support screw 190. Lever rod 199 is inserted into drive shaft hole 163c. Remove the screws from points 167c.

### Common Bus Assembly

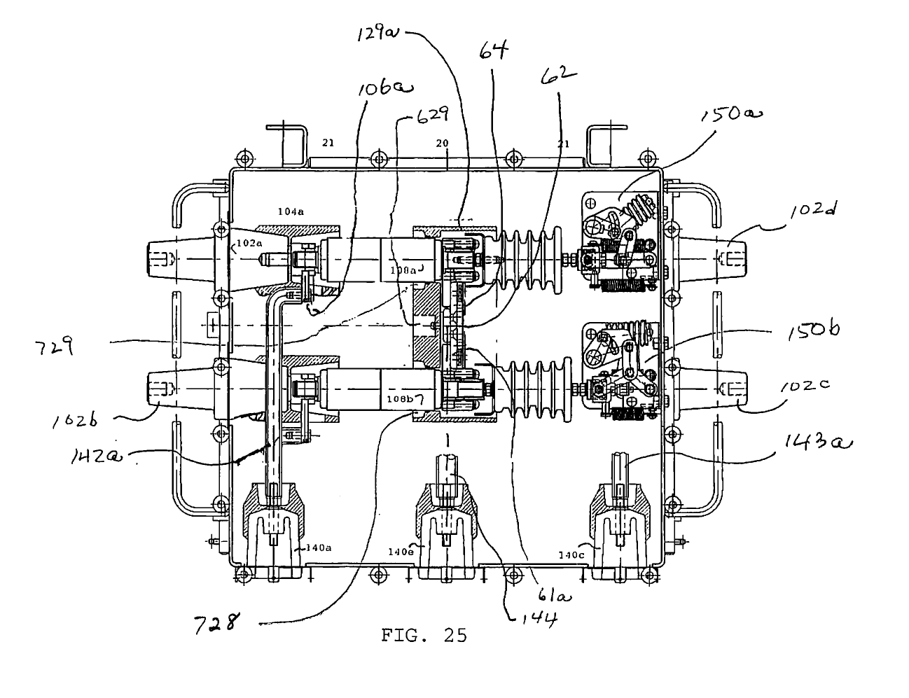

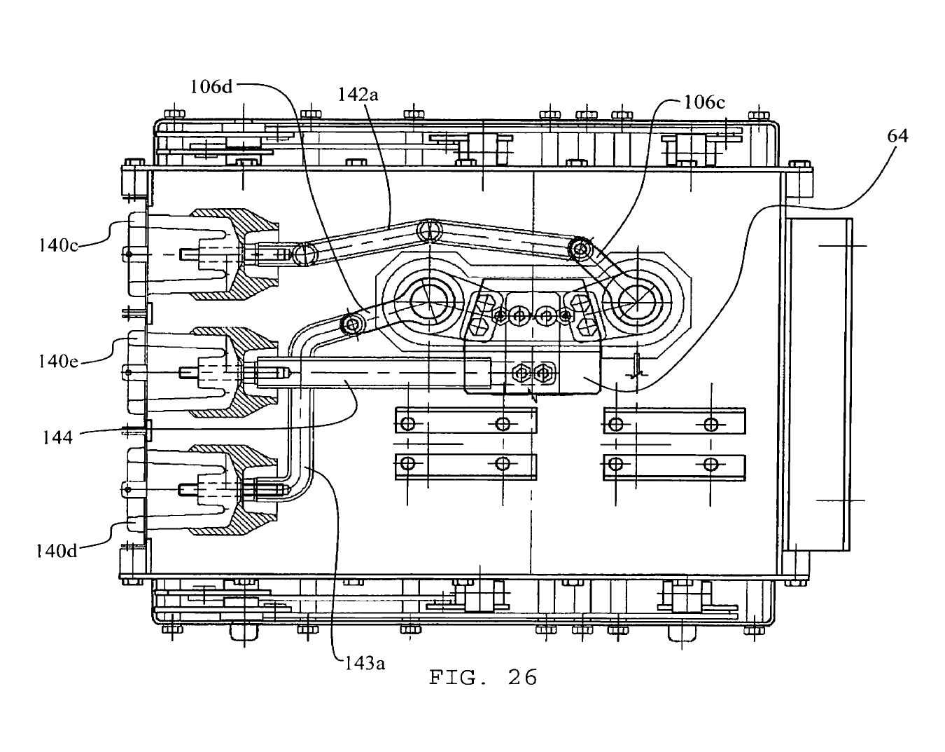

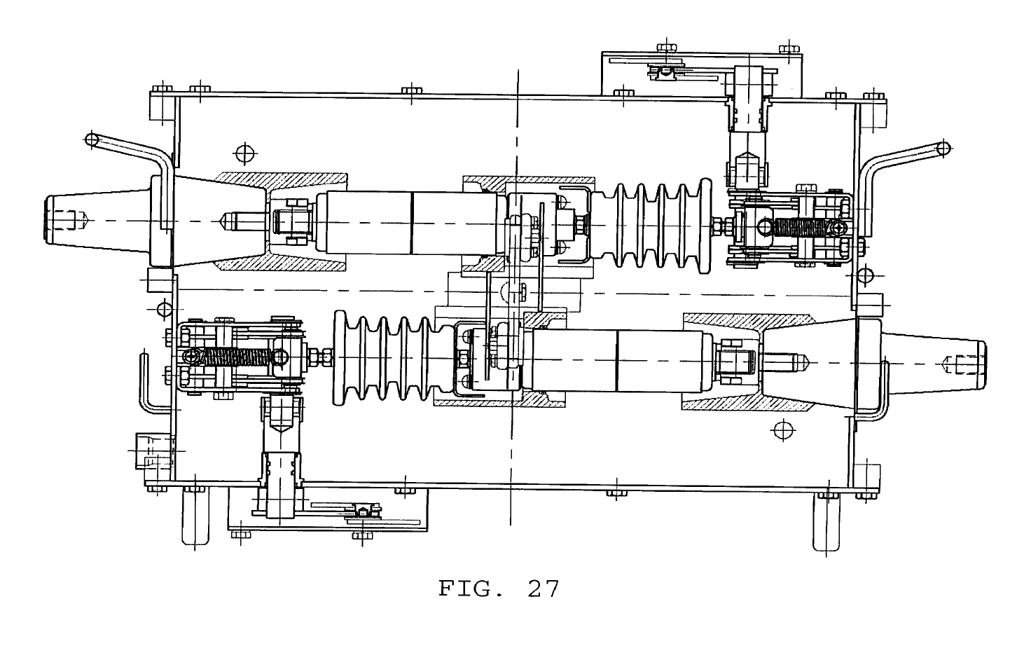

FIGS. 8, 25, 26, and 27 show views of a common bus assembly according to the present invention. Common bus assembly generally includes trapezoidal-shaped bus 61a and 61b screwed into place on opposite sides and opposite ends of rectangular-shaped bus 62. The shorter sides face away from each other. Holes 61c of trapezoidal-shaped bus 61a and holes 62a of rectangular bus 62 are used to screw the two buses together. Holes in trapezoidal-shaped bus 61b and holes in rectangular bus 62 are used to screw the two buses together.

### Housing Assembly

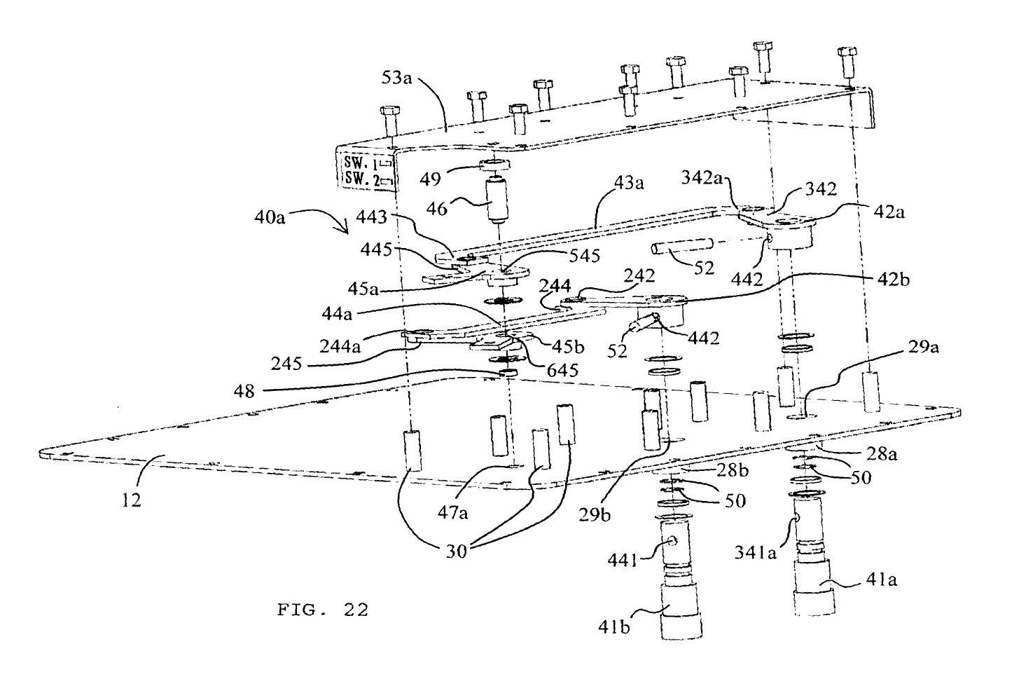

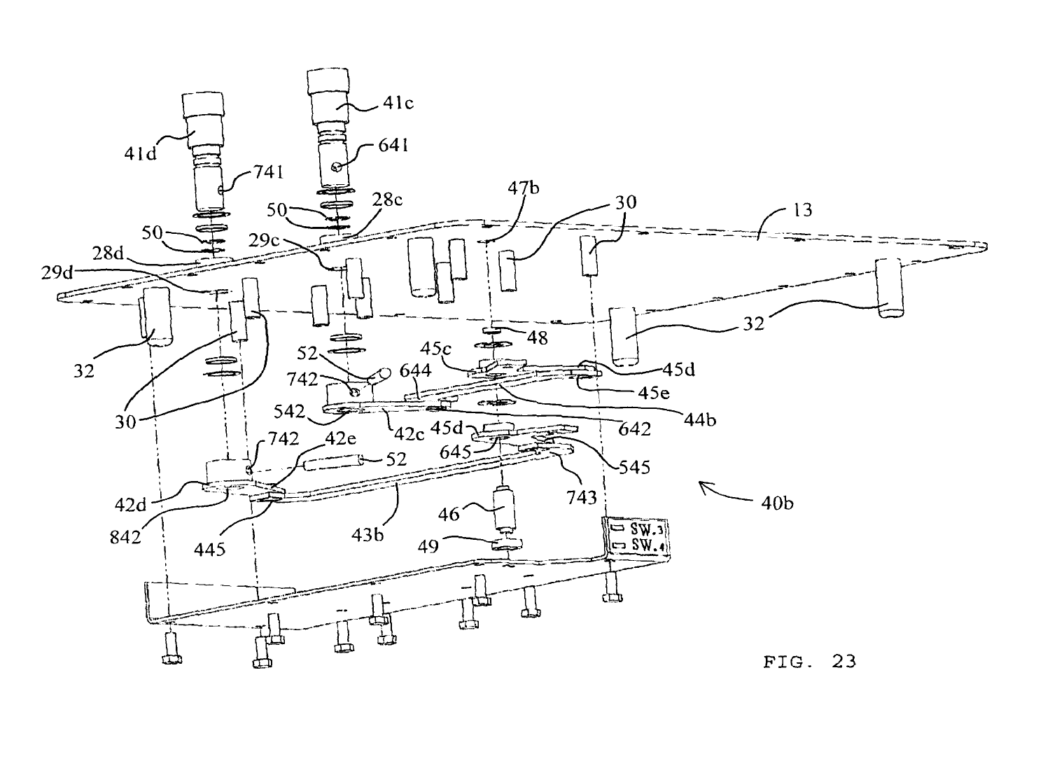

FIGS. 1-4 show views of the housing 10 according to the present invention. Housing 10 generally includes tank sidings 11a through 11d, bottom 13, and lid 12. Bottom 13 has footings 32 preferably welded to it and control assembly 40b and control assembly cover 53b bolted securely to it with holes along its edges for bolting to the threaded bolting studs 18 on tank sidings 11a, 11b, 11c, and 11d. Lid 12 has control assembly 40a and control assembly cover 53a bolted securely to it. See FIGS. 22 and 23.

Tank siding 11a has handle 14, stabilizing bar 15, threaded lifting studs 16, gas vent 17, threaded bolting studs 18, a grounding stud 19 and holes for power bushing 102a and 102b. Tank siding 11b has threaded bolting studs 18 and holes for bushing wells 140a, 140b, 140c, 140d, and 140e. Tank siding 11c has handle 14, stabilizing bar 15, threaded lifting studs 16, threaded bolting studs 18, grounding stud 19 and holes for power bushing 102c and 102d. Tank siding 11d has a stabilizing bar 20, threaded bolting studs 18 and mounting brackets 21. All components on the tank sidings are welded to the siding. After the internal components have been welded or bolted into place, bottom 13 and lid 12 are bolted and welded to tank sidings 11a, 11 b, 11c, 11d.

Referring to FIG. 5, O-rings 23 are fitted into grooves 24 on gas vent plug 22 and inserted into gas vent 17. Holes 26 of gas vent 17 and holes 25 of gas vent plug 22 are aligned and cotter pin 27 is inserted.

Referring to FIGS. 22 and 23, control shaft wells 28a and 28b are welded to lid 12 at control shaft points 29a and 29b. Threaded cover spacers 30 are welded to lid 12. Control shaft wells 28c and 28d are welded to bottom 13 at control shaft points 29c and 29d. Footing 32 is welded to bottom 13. Threaded cover spacers 30 are welded to bottom 13.

FIGS. 22 and 23 illustrate expanded views of control assembly 40a and 40b according to the present invention and is generally comprised of a control shaft 41a, 41b, 41c, 41d, a control arm 42a, 42b, 42c, 42d, either a long arm link 43a, 43b or a short arm link 44a, 44b, and handle arm 45a, 45b, 45c, 45d. Top control assembly 40a is assembled by fastening end 242 of control arm 42b to end 244 of short arm link 44a with a flathead pin and welded. End 244a of short arm link 44a is fastened to end 245 of handle arm 45b with a flathead pin and welded. End 342 of control arm 42a is fastened to end 342a of long arm link 43a with a flathead pin and welded. End 443 of long arm link 43a is fastened to end 445 of handle arm 45a with a flathead pin and welded. A pivot spacer 46 is inserted through handle arm 45a at pivot point 545, through a washer, into handle arm 45b at pivot point 645, through a washer and spacer 48, and into hole 47a of lid 12. A plastic spacer 49 is placed around the top end of pivot spacer 46. Bottom control assembly 40b is assembled by fastening end 642 of control arm 42c to end 45d of short arm link 44b with a flathead pin and welded. End 45e of short arm link 44b is fastened to end 644 of handle arm 45c with a flathead pin and welded. End 42e of control arm 42d is fastened to end 443 of long arm link 43b with a flathead pin and welded. End 743 of long arm link 43b is fastened to end 545 of handle arm 45d with a flathead pin and welded. A pivot spacer 46 is inserted through handle arm 45d at pivot point 645, through a washer, into handle arm 45c, through a washer and spacer 48, and into hole 47b of bottom 13. A plastic spacer 49 is placed around the bottom end of pivot spacer 46.

A washer and spacer are placed onto control shafts 41a, 41b, 41c, 41d. O-rings 50 are fitted into the grooves 51 on control shafts 41a, 41b, 41c, 41d. End of control shaft 41a is inserted through control shaft well 28a of lid 12, through a spacer and washer and into control arm 42a. Hole 341a of control shaft 41a is aligned with hole 442 of control arm 42a and a locking rod 52 is inserted through the holes. End of control shaft 41b is inserted through control shaft well 28b of lid 12, through a spacer and washer and into control arm 42b. Hole 441 of control shaft 41b is aligned with hole 442 of control arm 42b and a locking rod 52 is inserted through the holes. End of control shaft 41c is inserted through control shaft well 28c of bottom 13, through a spacer and washer and into control arm 42c at pivot opening 542. Hole 641 of control shaft 41c is aligned with hole 742 of control arm 42c and a locking rod 52 is inserted through the holes. End of control shaft 41d is inserted through control shaft well 28d of bottom 13, through a spacer and washer and into control arm 42d at the pivot opening 842. Hole 741 of control shaft 41d is aligned with hole 742 of control arm 42d and a locking rod 52 is inserted through the holes.

The top control assembly cover 53a is aligned and secured to cover spacers 30 with washers and bolts. The bottom control assembly cover 53b is aligned and secured to cover spacers 30 with washers and bolts.

### Assembling the Switch

### Vacuum Interrupter Switch Assembly

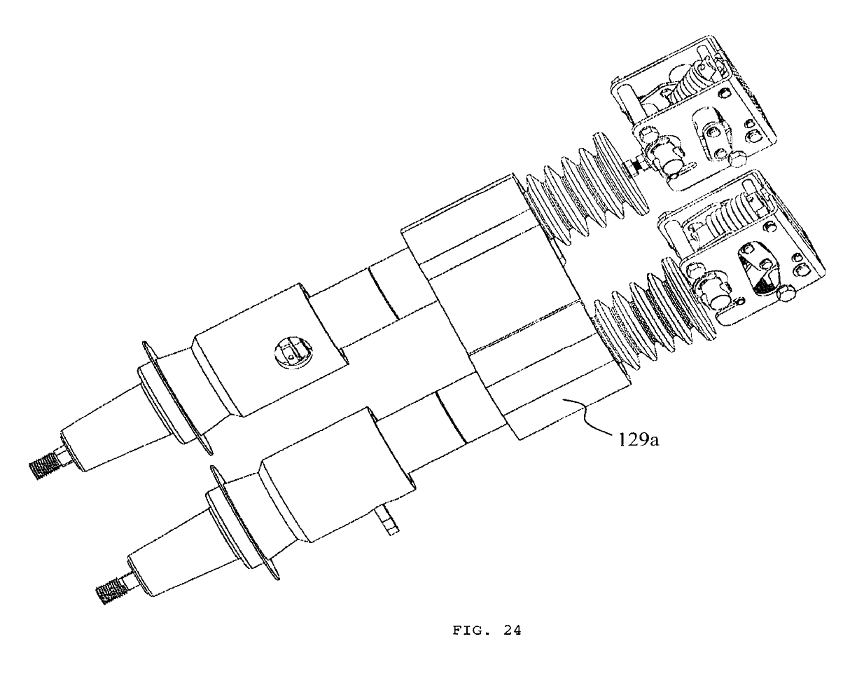

Referring to FIGS. 7, 8, 9 and 24, a vacuum interrupter switch assembly according to the present invention is illustrated. Vacuum interrupter switch assemblies 100a, 100b, 100c, 100d generally include a front section comprising of a power bushing 102 with a molded insulation shield 104 and a back section comprising of a threaded stud adapter 130, connector 106 to a bushing well 140, a vacuum interrupter bottle 108, a common bus connector 110 with multilam contacts 112, an insulation collar 114, a push-pull insulator 116, and an operating mechanism assembly.

According to the present invention, Vacuum Interrupter Switch Assemblies 100a, 100b, 100c, 100d are assembled into housing 10 as follows:

A cylindrical epoxy insulation shield 104a, 104b, 104c, 104d is molded onto power bushings 102a, 102b, 102c, 102d, respectively. Power bushing 102a with insulation shield 104a is inserted into hole 34a of tank siding 11a. Power bushing 102b with insulation shield 104b is inserted into hole 34b of tank siding 11a. Power bushing 102c with insulation shield 104c is inserted into hole 34c of tank siding 11c. Power bushing 102d with insulation shield 104d is inserted into hole 34d of tank siding 11c. Power bushings 102a and 102b are welded to tank siding 11a. Power bushings 102c and 102d are welded to tank siding 11c.

Each of the cylindrical epoxy insulation shield 141a, 141b, 141c, 141d are molded onto bushing well 140a, 140b, 140c, 140d. Bushing well 140a with insulation shield 141a is inserted into hole 35a of tank siding 11b. Bushing well 140b with insulation shield 141b is inserted into hole 35b of tank siding 11b. Bushing well 140c with insulation shield 141c is inserted into hole 35c of tank siding 11b. Bushing well 140d with insulation shield 141d is inserted into hole 35d of tank siding 11b. Bushing well 140e with insulation shield 141e is inserted into hole 35e of tank siding 11b. Bushing wells 140a, 140b, 140c, 140d are all welded to tank siding 11b.

A threaded stud adapter 130 is screwed into power bushing 102a. Bushing well connector 106a is installed onto threaded stud adapter 130 with the rectangular portion extending out through hole of insulation shield 104a. Nut 128 is screwed onto threaded stud adapter 130 to lock bushing well connector 106a into place. Stationary contact 108f of vacuum interrupter bottle 108a is fitted with a spring washer 127 and screwed into threaded stud adapter 130. An O-ring 122 is temporarily fitted onto vacuum interrupter bottle 108a. This procedure is repeated for power bushing 102b, 102c, 102d and vacuum interrupter bottles 108b, 108c, 108d.

Insulation cover 129a is temporarily installed over vacuum interrupter bottles 108a and 108b through the holes.

An insulating plate 118 is placed around moveable contact 108e of vacuum interrupter bottle 108a. Four insulating cylinders 119 cover the four short studs surrounding moveable contact 108e. A short threaded cylindrical contact 121 and a long threaded cylindrical contact 120 is screwed onto moveable contact 108e and tightened against one another. A headless bolt 126 is screwed into the internal thread of movable contact 108e and tightened with a nut and washer.

An insulating plate 118 is placed around moveable contact 108e of the vacuum interrupter bottle 108b. Four insulating cylinders 119 cover the four short studs surrounding moveable contact 108e of the vacuum interrupter bottle 108b. A short threaded cylindrical contact 121 and a long threaded cylindrical contact 120 is screwed onto moveable contact 108e and tightened against one another. A headless bolt 126 is screwed into the internal thread of movable contact 108e and tightened with a nut and washer.

Common bus connector 110a, as illustrated in FIG. 9, has grooves 111 (not shown) inside. Multilam contacts 112 are fitted into the grooves and secured with C-clips 113. The four common bus connectors are substantially identically in structure.

Common bus connector 110a is installed onto vacuum interrupter bottle 108a by aligning its four holes with the four studs surrounding movable contact 108e. An insulating spacer 124 is inserted between common bus connector 110a and long threaded cylindrical contact 120. The four holes for insulating spacer 124 are aligned with the four holes in common bus connector 110a. Four screws with lock washers are inserted into insulating tubes 123 which are then inserted through the four holes in insulating spacer 124 and common bus connector 110a and screwed into the four threaded studs surrounding movable contact 108e.

The same procedure also applies to the assembly of common bus connector 110b.

Bolt 126 is inserted through a washer, insulating collar 114a, and screwed into threaded hole of push-pull insulator 116a. Bolt 176 of operating mechanism 150a is screwed into threaded hole of push-pull insulator 116a.

Bolt 126 is inserted through a washer, insulating collar 114b, and screwed into threaded hole of push-pull insulator 116b. Bolt 176 of operating mechanism 150b is screwed into threaded hole of push-pull insulator 116b.

The same procedure also applies to the vacuum interrupter switch assembly 100c and 100d.

Trapezoidal-shaped bus 61a is bolted through holes to common bus connector 110a of vacuum interrupter switch assembly 100a through holes. Trapezoidal-shaped bus 61a is bolted through holes to common bus connector 110b of vacuum interrupter switch assembly 100b through holes. Trapezoidal-shaped bus 61b is bolted through holes to common bus connector 110c of vacuum interrupter switch assembly 100c through holes. Trapezoidal-shaped bus 61b is bolted through holes to common bus connector 110d of vacuum interrupter switch assembly 100d through holes.

A screw with washers is inserted through hole of insulation cover 129a, through a spacer 63, and into a threaded hole of the rectangular-shaped bus 62. A screw with washers is inserted through a hole of the insulation cover 129b, a spacer 63, and into threaded hole of rectangular-shaped bus 62.

An O-ring 122 is slid into the groove in between vacuum interrupter bottle 108b and insulation cover 129a. An O-ring 122 is slid into the groove between vacuum interrupter bottle 108a and insulation cover 129a. An O-ring 122 is slid into the groove in between vacuum interrupter bottle 108d and insulation cover 129b. An O-ring 122 is slid into the groove in between vacuum interrupter bottle 108c and insulation cover 129b.

Vacuum interrupter assembly 100a is bolted to tank siding 11c at its mounting point and 201h, 201i, 202h, and 202i of the operating mechanism 150a. Vacuum interrupter assembly 100b is bolted to tank siding 11c through its mounting point and 201h, 201i, 202h, and 202i of operating mechanism 150b. Vacuum interrupter assembly 100c is bolted to tank siding 11a through mounting points 36c and 201h, 201i, 202h, and 202i of operating mechanism 150c. Vacuum interrupter assembly 100d is bolted to tank siding 11a through its mounting point and 201h, 201i, 202h, and 202i of operating mechanism 150d.

Referring to FIGS. 5, 6, 25 and 26, one end of connection bus 144 is installed onto bushing well 140e. The other end of connection bus 144 is bolted to rectangular-shaped bus 62. One end of connection bus 142a is installed onto bushing well 140a and the other end is bolted to bushing well connector 106a with a copper bolt. A set screw is screwed into a threaded hole of bushing well connector 106a. One end of connection bus 143a is installed onto bushing well 140b and the other end is bolted to bushing well connector 106b with a copper bolt. A set screw is screwed into threaded hole of bushing well connector 106b. One end of connection bus 143b is installed onto bushing well 140c and the other end is bolted to bushing well connector 106c with a copper bolt. A set screw is screwed into a threaded hole of bushing well connector 106c. One end of connection bus 142b is installed onto bushing well 140d and the other end is bolted to bushing well connector 106d with a copper bolt. A set screw is screwed into a threaded hole of bushing well connector 106d. All connection buses are covered with insulation material.

An insulating plate 64 is fastened to trapezoidal-shaped bus 61a with fitting screws. Another insulating plate 64 is fastened to trapezoidal-shaped bus 61b with fitting screws. The fitting screws are covered with a polysiloxane gel.

Hydrocarbon foam is poured into hole 629 and one or more other holes of insulation cover 129a and 129b, respectively. A circular mold is placed around vacuum interrupter bottle 108a and opening 729 of insulation cover 129a as well as vacuum interrupter bottle 108b and opening 728 of insulation cover 129a. Hydrocarbon foam is poured inside the molds. A circular mold is placed around vacuum interrupter bottle 108c and the opening 729 in insulation cover 129b as well as vacuum interrupter bottle 108d and the opening 728 in insulation cover 129b. Hydrocarbon foam is poured inside the molds.

A circular mold is placed around vacuum interrupter bottle 108a and the opening of insulation shield 104a and filled with hydrocarbon foam. A circular mold is placed around vacuum interrupter bottle 108b and the opening in insulation shield 104b and filled with hydrocarbon foam. A circular mold is placed around vacuum interrupter bottle 108c and the opening in insulation shield 104c and filled with hydrocarbon foam. A circular mold is placed around vacuum interrupter bottle 108d and the opening in insulation shield 104d and filled with hydrocarbon foam.

A cylindrical mold is placed over the hole of insulation shield 104a and end of connection bus 142a and filled with hydrocarbon foam. A cylindrical mold is placed over the hole of insulation shield 104b and the end of connection bus 143a and filled with hydrocarbon foam. A cylindrical mold is placed over the hole of insulation shield 104c and the end of connection bus 143b and filled with hydrocarbon foam. A cylindrical mold is placed over the hole of insulation shield 104d and the end of connection bus 142b and filled with hydrocarbon foam.

A circular mold is placed around the end of connection bus 142a and the connection point of bushing well 140a and filled with hydrocarbon foam. A circular mold is placed around the end of connection bus 143a and the connection point of bushing well 140b and filled with hydrocarbon foam. A circular mold is placed around the end of connection bus 143b and the connection point of bushing well 140c and filled with hydrocarbon foam. A circular mold is placed around the end of connection bus 142b and the connection point of bushing well 140d and filled with hydrocarbon foam. A circular mold is placed around the end of connection bus 144 and the connection point of bushing well 140e and filled with hydrocarbon foam.

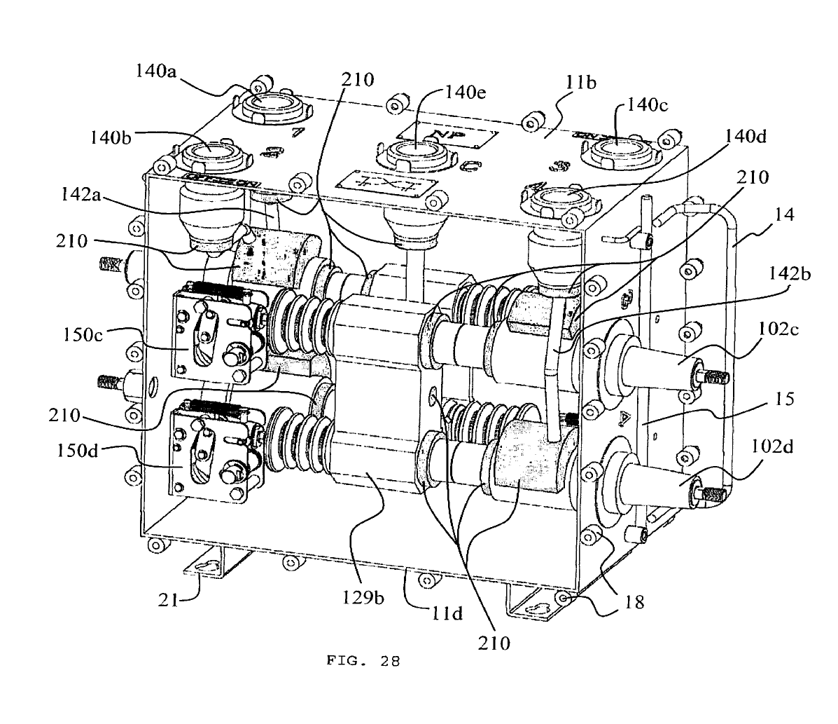

All the molds are removed once the hydrocarbon foam has gelled. FIG. 28 illustrates the hydrocarbon foam 210 after it has gelled on the components. For clarity, the hydrocarbon foam 210 is shown shaded in FIG. 28.

The end of control shaft 41c and the end of control shaft 41d are aligned with and placed onto the end of drive shaft 163 for operating mechanisms 150c and 150d, respectively. Bottom 13 is bolted to the lower threaded bolting studs 18 of tank sidings 11a, 11b, 11c and 11d. Bottom 13 is welded to tank sidings 11a, 11b, 11c and 11d and the bolts are welded to the threaded bolting studs 18. The end of control shaft 41a and the end of control shaft 41b are aligned with and placed onto the end of drive shaft 163 for operating mechanisms 150a and 150b, respectively. Lid 12 is bolted to the upper threaded bolting studs 18 of tank sidings 11a, 11b, 11c and 11d. Lid 12 is welded to tank sidings 11a, 11b, 11c and 11d and the bolts are welded to the threaded bolting studs 18.

A standard removable handle 220 is shown in FIG. 1. As an option, unique keyed handles can be made and used.

As an option, gel or insulating oil can be poured into housing assembly 10 before lid 12 is welded on.

As an option, components can be added to housing 10 which can lock the control assemblies in place to prevent improper operation.

Although the present invention and its advantages have been described in detail, it should be understood that various changes, substitutions and alterations can be made herein without departing from the spirit and scope of the invention as will be defined by appended claims.

We claim:

1. A vacuum interrupter switch comprising:
an enclosure;
a plurality of vacuum interrupter bottle switches positioned within the enclosure;
a bus positioned within the enclosure electrically connected to the vacuum interrupter bottle switches;
wherein the enclosure is capable of passing through a circular opening having a diameter of 30 inches.

2. A vacuum interrupter switch substantially as shown and described.
